(19) United States
(12) Patent Application Publication
(10) Pub. No.: US 2024/0062362 A1
(43) Pub. Date: Feb. 22, 2024

(54) MACHINE LEARNING-BASED SYSTEMS AND METHODS FOR GENERATING SYNTHETIC DEFECT IMAGES FOR WAFER INSPECTION

(71) Applicant: ASML Netherlands B.V., Veldhoven (NL)

(72) Inventors: Zhe WANG, Dublin, CA (US); Liangjiang YU, Pleasanton, CA (US); Lingling PU, San Jose, CA (US)

(73) Assignee: ASML Netherlands B.V., Veldhoven (NL)

(21) Appl. No.: 18/268,953

(22) PCT Filed: Dec. 8, 2021
(86) PCT No.: PCT/EP2021/084837

§ 371 Date: Jun. 21, 2023

Related U.S. Application Data
(60) Provisional application No. 63/128,772, filed on Dec. 21, 2020.

(51) Int. Cl. G06T 7/00; G06T 11/00

(52) U.S. Cl. CPC G06T 7/001; G06T 11/00; G06T 2207/20084; G06T 2207/20081; G06T 2207/30148; G06T 2207/10061

(57) ABSTRACT

An improved systems and methods for generating a synthetic defect image are disclosed. An improved method for generating a synthetic defect image comprises acquiring a machine learning-based generator model; providing a defect-free inspection image and a defect attribute combination as inputs to the generator model; and generating by the generator model, based on the defect-free inspection image, a predicted synthetic defect image with a predicted defect that accords with the defect attribute combination.

### CROSS-REFERENCE TO RELATED APPLICATIONS

This application claims priority of U.S. application 63/128,772 which was filed on Dec. 21, 2020 and which is incorporated herein in its entirety by reference.

### TECHNICAL FIELD

The embodiments provided herein relate to a synthetic defect image generation technology, and more particularly to synthetic defect image generation for wafer inspection in a charged-particle beam inspection.

### BACKGROUND

In manufacturing processes of integrated circuits (ICs), unfinished or finished circuit components are inspected to ensure that they are manufactured according to design and are free of defects. Inspection systems utilizing optical microscopes or charged particle (e.g., electron) beam microscopes, such as a scanning electron microscope (SEM) can be employed. As the physical sizes of IC components continue to shrink, accuracy and yield in defect detection become more important.

As inspection processes, inspection images such as SEM images may be subject to image enhancement, defect detection, defect classification, etc. Machine learning or deep learning techniques may be utilized in such inspection processes. To improve defect inspection performance, training machine learning or deep learning models for inspecting inspection images with sufficient amounts of training defect images is desired.

### SUMMARY

The embodiments provided herein disclose a particle beam inspection apparatus, and more particularly, an inspection apparatus using a plurality of charged particle beams.

In some embodiments, a method for generating a synthetic defect image is disclosed. The method comprises acquiring a machine learning-based generator model; providing a defect-free inspection image and a defect attribute combination as inputs to the generator model; and generating by the generator model, based on the defect-free inspection image, a predicted synthetic defect image with a predicted defect that accords with the defect attribute combination.

In some embodiments, an apparatus for generating a synthetic defect image is disclosed. The method comprises a memory storing a set of instructions; and at least one processor configured to execute the set of instructions to cause the apparatus to perform: acquiring a machine learning-based generator model; providing a defect-free inspection image and a defect attribute combination as inputs to the generator model; and generating by the generator model, based on the defect-free inspection image, a predicted synthetic defect image with a predicted defect that accords with the defect attribute combination.

In some embodiments, a non-transitory computer readable medium that stores a set of instructions that is executable by at least one processor of a computing device to cause the computing device to perform a method for generating a synthetic defect image is disclosed. The method comprises acquiring a machine learning-based generator model; providing a defect-free inspection image and a defect attribute combination as inputs to the generator model; and generating by the generator model, based on the defect-free inspection image, a predicted synthetic defect image with a predicted defect that accords with the defect attribute combination.

In some embodiments, a method for training a machine learning-based generator model for generating a synthetic defect image is disclosed. The method comprises acquiring a first training defect-free inspection image and a first training defect attribute combination associated with a first training defect-containing inspection image; generating, by the generator model, based on the first training defect-free inspection image, a first predicted synthetic defect image with a first predicted defect that accords with the first training defect attribute combination; evaluating whether the first predicted synthetic defect image is classified as a real inspection image under a condition of the first training defect attribute combination; and in response to the evaluation that the first predicted synthetic defect image is not a real inspection image, updating the generator model.

In some embodiments, an apparatus for training a machine learning-based generator model for generating a synthetic defect image is disclosed. The apparatus comprises a memory storing a set of instructions; and at least one processor configured to execute the set of instructions to cause the apparatus to perform: acquiring a first training defect-free inspection image and a first training defect attribute combination associated with a first training defect-containing inspection image; generating, by the generator model, based on the first training defect-free inspection image, a first predicted synthetic defect image with a first predicted defect that accords with the first training defect attribute combination; evaluating whether the first predicted synthetic defect image is classified as a real inspection image under a condition of the first training defect attribute combination; and in response to the evaluation that the first predicted synthetic defect image is not a real inspection image, updating the generator model.

In some embodiments, a non-transitory computer readable medium that stores a set of instructions that is executable by at least one processor of a computing device to cause the computing device to perform a method for training a machine learning-based generator model for generating a synthetic defect image is disclosed. The method comprises acquiring a first training defect-free inspection image and a first training defect attribute combination associated with a first training defect-containing inspection image; generating, by the generator model, based on the first training defect-free inspection image, a first predicted synthetic defect image with a first predicted defect that accords with the first training defect attribute combination; evaluating whether the first predicted synthetic defect image is classified as a real inspection image under a condition of the first training defect attribute combination; and in response to the evaluation that the first predicted synthetic defect image is not a real inspection image, updating the generator model.

Other advantages of the embodiments of the present disclosure will become apparent from the following description taken in conjunction with the accompanying drawings wherein are set forth, by way of illustration and example, certain embodiments of the present invention.

### BRIEF DESCRIPTION OF FIGS

The above and other aspects of the present disclosure will become more apparent from the description of exemplary embodiments, taken in conjunction with the accompanying drawings.

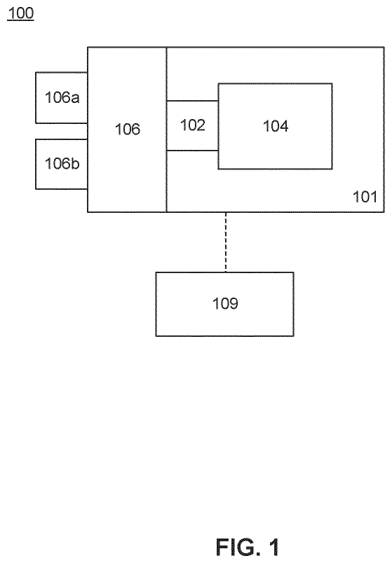

FIG. 1 is a schematic diagram illustrating an example charged-particle beam inspection system, consistent with embodiments of the present disclosure.

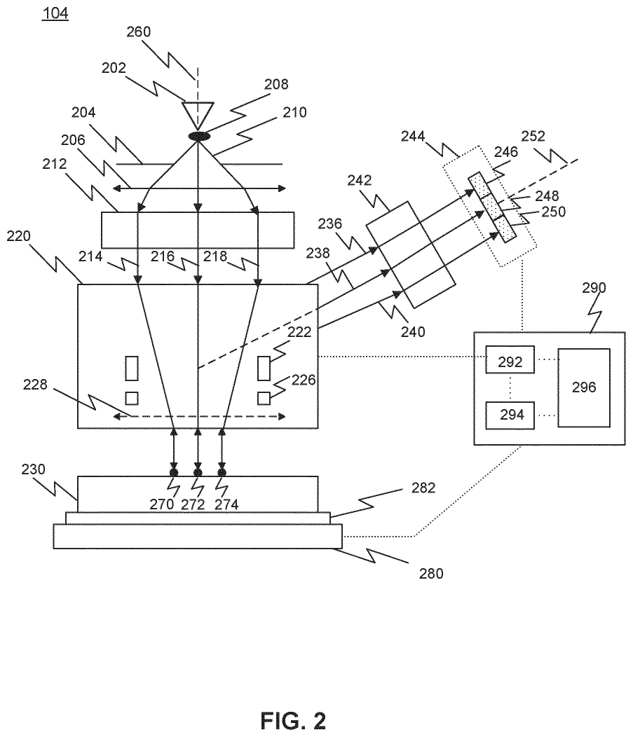

FIG. 2 is a schematic diagram illustrating an example multi-beam tool that can be a part of the example charged-particle beam inspection system of FIG. 1, consistent with embodiments of the present disclosure.

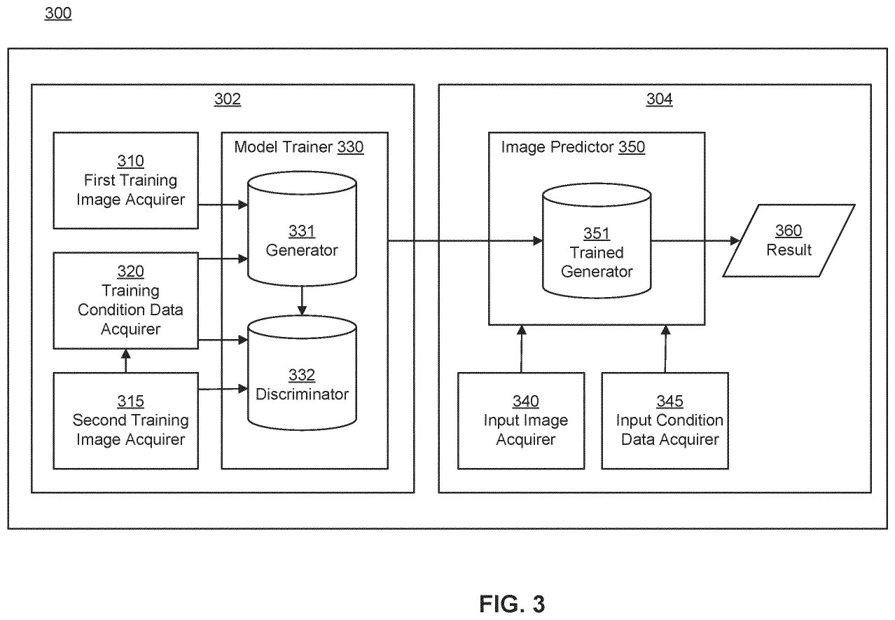

FIG. 3 is a block diagram of an example synthetic defect image generation system, consistent with embodiments of the present disclosure.

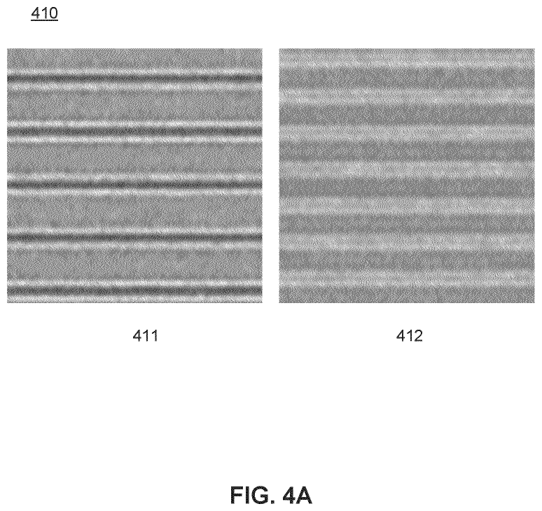

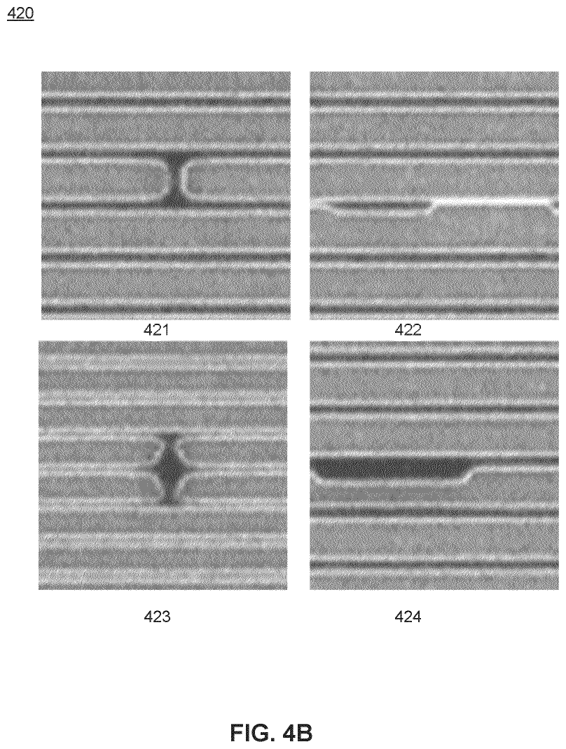

FIG. 4A illustrates example training defect-free inspection images, consistent with embodiments of the present disclosure.

FIG. 4B illustrates example training defect-containing inspection images, consistent with embodiments of the present disclosure.

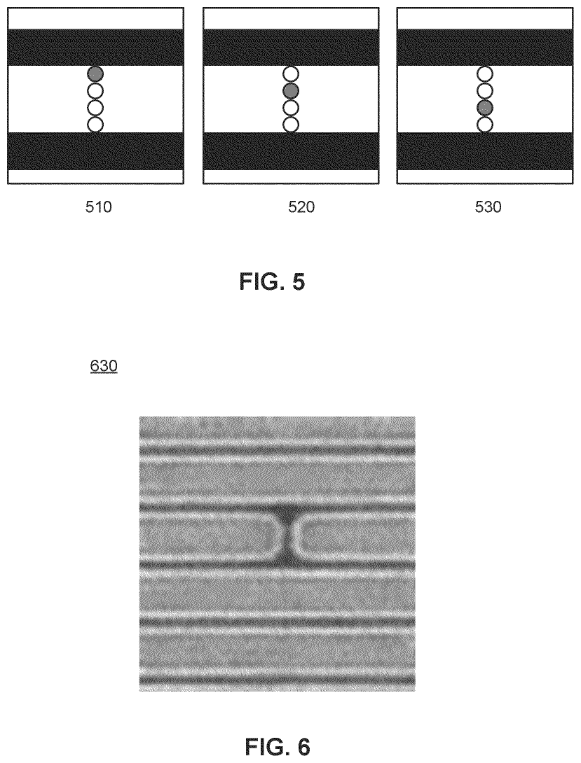

FIG. 5 illustrates example defect locations in an inspection image, consistent with embodiments of the present disclosure.

FIG. 6 illustrates an example predicted synthetic defect image, consistent with embodiments of the present disclosure.

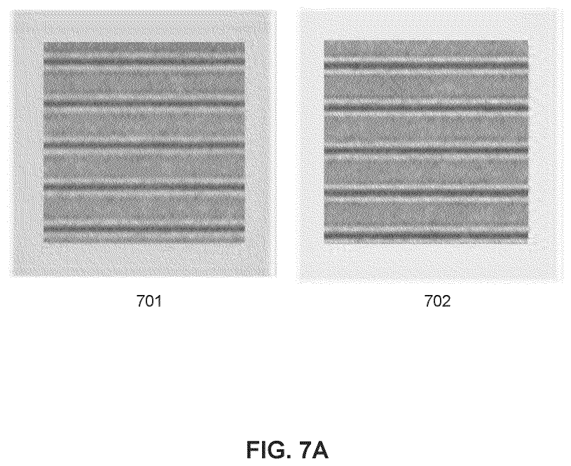

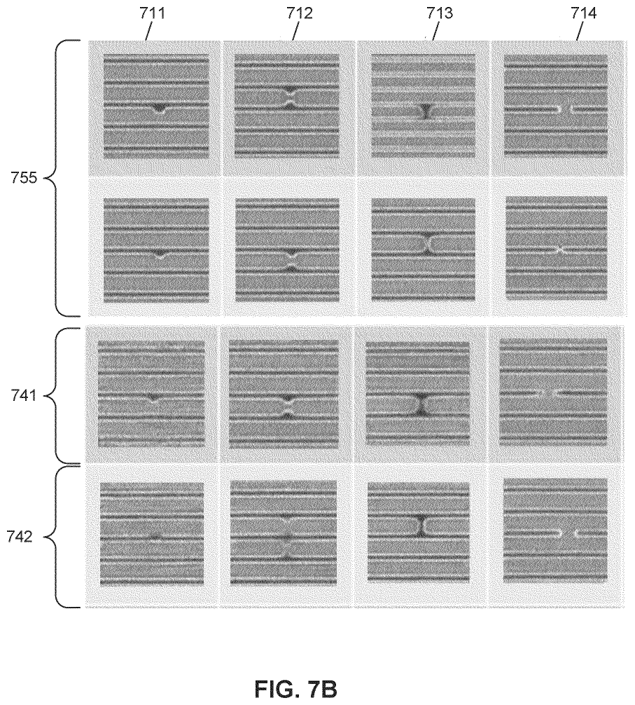

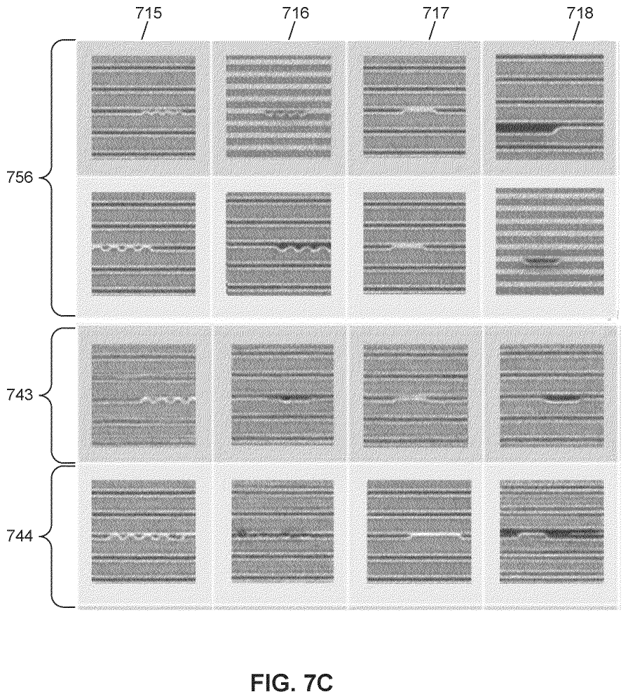

FIG. 7A illustrates example input images for synthetic defect image generation, consistent with embodiments of the present disclosure.

FIG. 7B illustrates a first set of example defect types and corresponding synthetic defect images, consistent with embodiments of the present disclosure.

FIG. 7C illustrates a second set of example defect types and corresponding synthetic defect images, consistent with embodiments of the present disclosure.

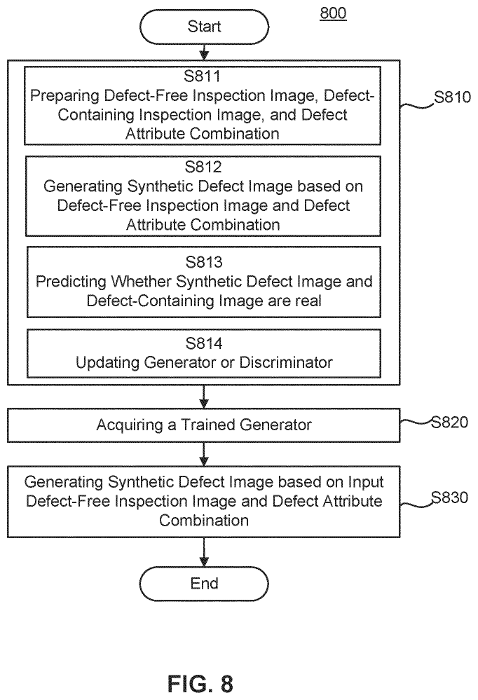

FIG. 8 is a process flowchart representing an example method for generating synthetic defect images, consistent with embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations. Instead, they are merely examples of apparatuses and methods consistent with aspects related to the disclosed embodiments as recited in the appended claims. For example, although some embodiments are described in the context of utilizing electron beams, the disclosure is not so limited. Other types of charged particle beams may be similarly applied. Furthermore, other imaging systems may be used, such as optical imaging, photo detection, x-ray detection, etc.

Electronic devices are constructed of circuits formed on a piece of semiconductor material called a substrate. The semiconductor material may include, for example, silicon, gallium arsenide, indium phosphide, or silicon germanium, or the like. Many circuits may be formed together on the same piece of silicon and are called integrated circuits or ICs. The size of these circuits has decreased dramatically so that many more of them can be fit on the substrate. For example, an IC chip in a smartphone can be as small as a thumbnail and yet may include over 2 billion transistors, the size of each transistor being less than 1/1000 the size of a human hair.

Making these ICs with extremely small structures or components is a complex, time-consuming, and expensive process, often involving hundreds of individual steps. Errors in even one step have the potential to result in defects in the finished IC, rendering it useless. Thus, one goal of the manufacturing process is to avoid such defects to maximize the number of functional ICs made in the process; that is, to improve the overall yield of the process.

One component of improving yield is monitoring the chip-making process to ensure that it is producing a sufficient number of functional integrated circuits. One way to monitor the process is to inspect the chip circuit structures at various stages of their formation. Inspection can be carried out using a scanning charged-particle microscope (SCPM). For example, an SCPM may be a scanning electron microscope (SEM). A SCPM can be used to image these extremely small structures, in effect, taking a “picture” of the structures of the wafer. The image can be used to determine if the structure was formed properly in the proper location. If the structure is defective, then the process can be adjusted, so the defect is less likely to recur.

As the physical sizes of IC components continue to shrink, accuracy and yield in defect detection become more important. During a defect inspection process, inspection images, such as SEM images, may be subject to image enhancement, defect detection, defect classification, etc. and machine learning or deep learning techniques may be utilized to perform such processes. In order for machine learning or deep learning models to be used for inspecting SEM images, the models may be trained with a training data set comprising SEM defect images. For accuracy and high performance defect inspection, it is desirable to prepare a training data set that includes various SEM defect images. However, collecting sufficient samples of SEM defect images is time consuming and costly because occurrence of critical defects is sparse and random in a SEM image. Further, it may not be practical to collect equal or balanced amounts of sample defect images for differing defects, e.g., within research and development timeline requirements.

One approach to address the issue is to generate defect images through simple manipulation, (e.g., random shifting, rotating, flipping, etc.) to existing SEM defect images. However, merely a copy of existing SEM defect images is obtained via such manipulation. Some embodiments of the present disclosure provide machine learning-based methods and systems for generating synthetic defect images that can be used for training machine learning or deep learning models designed to inspect defects for image enhancement, defect detection, defect classification, etc. from wafer inspection images. In the present disclosure, various synthetic defect images having a defect attribute of interest, such as a defect type, defect size, defect location, etc. can be generated.

Relative dimensions of components in drawings may be exaggerated for clarity. Within the following description of drawings, the same or like reference numbers refer to the same or like components or entities, and only the differences with respect to the individual embodiments are described. As used herein, unless specifically stated otherwise, the term “or” encompasses all possible combinations, except where infeasible. For example, if it is stated that a component may include A or B, then, unless specifically stated otherwise or infeasible, the component may include A, or B, or A and B. As a second example, if it is stated that a component may include A, B, or C, then, unless specifically stated otherwise or infeasible, the component may include A, or B, or C, or A and B, or A and C, or B and C, or A and B and C.

FIG. 1 illustrates an example electron beam inspection (EBI) system 100 consistent with embodiments of the present disclosure. EBI system 100 may be used for imaging. As shown in FIG. 1, EBI system 100 includes a main chamber 101, a load/lock chamber 102, a beam tool 104, and an equipment front end module (EFEM) 106. Beam tool 104 is located within main chamber 101. EFEM 106 includes a first loading port 106a and a second loading port 106b. EFEM 106 may include additional loading port(s). First loading port 106a and second loading port 106b receive wafer front opening unified pods (FOUPs) that contain wafers (e.g., semiconductor wafers or wafers made of other material(s)) or samples to be inspected (wafers and samples may be used interchangeably). A “lot” is a plurality of wafers that may be loaded for processing as a batch.

One or more robotic arms (not shown) in EFEM 106 may transport the wafers to load/lock chamber 102. Load/lock chamber 102 is connected to a load/lock vacuum pump system (not shown) which removes gas molecules in load/lock chamber 102 to reach a first pressure below the atmospheric pressure. After reaching the first pressure, one or more robotic arms (not shown) may transport the wafer from load/lock chamber 102 to main chamber 101. Main chamber 101 is connected to a main chamber vacuum pump system (not shown) which removes gas molecules in main chamber 101 to reach a second pressure below the first pressure. After reaching the second pressure, the wafer is subject to inspection by beam tool 104. Beam tool 104 may be a single-beam system or a multi-beam system.

A controller 109 is electronically connected to beam tool 104. Controller 109 may be a computer configured to execute various controls of EBI system 100. While controller 109 is shown in FIG. 1 as being outside of the structure that includes main chamber 101, load/lock chamber 102, and EFEM 106, it is appreciated that controller 109 may be a part of the structure.

In some embodiments, controller 109 may include one or more processors (not shown). A processor may be a generic or specific electronic device capable of manipulating or processing information. For example, the processor may include any combination of any number of a central processing unit (or “CPU”), a graphics processing unit (or “GPU”), an optical processor, a programmable logic controllers, a microcontroller, a microprocessor, a digital signal processor, an intellectual property (IP) core, a Programmable Logic Array (PLA), a Programmable Array Logic (PAL), a Generic Array Logic (GAL), a Complex Programmable Logic Device (CPLD), a Field-Programmable Gate Array (FPGA), a System On Chip (SoC), an Application-Specific Integrated Circuit (ASIC), and any type circuit capable of data processing. The processor may also be a virtual processor that includes one or more processors distributed across multiple machines or devices coupled via a network.

In some embodiments, controller 109 may further include one or more memories (not shown). A memory may be a generic or specific electronic device capable of storing codes and data accessible by the processor (e.g., via a bus). For example, the memory may include any combination of any number of a random-access memory (RAM), a read-only memory (ROM), an optical disc, a magnetic disk, a hard drive, a solid-state drive, a flash drive, a security digital (SD) card, a memory stick, a compact flash (CF) card, or any type of storage device. The codes and data may include an operating system (OS) and one or more application programs (or “apps”) for specific tasks. The memory may also be a virtual memory that includes one or more memories distributed across multiple machines or devices coupled via a network.

FIG. 2 illustrates a schematic diagram of an example multi-beam tool 104 (also referred to herein as apparatus 104) and an image processing system 290 that may be configured for use in EBI system 100 (FIG. 1), consistent with embodiments of the present disclosure.

Beam tool 104 comprises a charged-particle source 202, a gun aperture 204, a condenser lens 206, a primary charged-particle beam 210 emitted from charged-particle source 202, a source conversion unit 212, a plurality of beamlets 214, 216, and 218 of primary charged-particle beam 210, a primary projection optical system 220, a motorized wafer stage 280, a wafer holder 282, multiple secondary charged-particle beams 236, 238, and 240, a secondary optical system 242, and a charged-particle detection device 244. Primary projection optical system 220 can comprise a beam separator 222, a deflection scanning unit 226, and an objective lens 228. Charged-particle detection device 244 can comprise detection sub-regions 246, 248, and 250.

Charged-particle source 202, gun aperture 204, condenser lens 206, source conversion unit 212, beam separator 222, deflection scanning unit 226, and objective lens 228 can be aligned with a primary optical axis 260 of apparatus 104. Secondary optical system 242 and charged-particle detection device 244 can be aligned with a secondary optical axis 252 of apparatus 104.

Charged-particle source 202 can emit one or more charged particles, such as electrons, protons, ions, muons, or any other particle carrying electric charges. In some embodiments, charged-particle source 202 may be an electron source. For example, charged-particle source 202 may include a cathode, an extractor, or an anode, wherein primary electrons can be emitted from the cathode and extracted or accelerated to form primary charged-particle beam 210 (in this case, a primary electron beam) with a crossover (virtual or real) 208. For ease of explanation without causing ambiguity, electrons are used as examples in some of the descriptions herein. However, it should be noted that any charged particle may be used in any embodiment of this disclosure, not limited to electrons. Primary charged-particle beam 210 can be visualized as being emitted from crossover 208. Gun aperture 204 can block off peripheral charged particles of primary charged-particle beam 210 to reduce Coulomb effect. The Coulomb effect may cause an increase in size of probe spots.

Source conversion unit 212 can comprise an array of image-forming elements and an array of beam-limit apertures. The array of image-forming elements can comprise an array of micro-deflectors or micro-lenses. The array of image-forming elements can form a plurality of parallel images (virtual or real) of crossover 208 with a plurality of beamlets 214, 216, and 218 of primary charged-particle beam 210. The array of beam-limit apertures can limit the plurality of beamlets 214, 216, and 218. While three beamlets 214, 216, and 218 are shown in FIG. 2, embodiments of the present disclosure are not so limited. For example, in some embodiments, the apparatus 104 may be configured to generate a first number of beamlets. In some embodiments, the first number of beamlets may be in a range from 1 to 1000. In some embodiments, the first number of beamlets may be in a range from 200-500. In an exemplary embodiment, an apparatus 104 may generate 400 beamlets.

Condenser lens 206 can focus primary charged-particle beam 210. The electric currents of beamlets 214, 216, and 218 downstream of source conversion unit 212 can be varied by adjusting the focusing power of condenser lens 206 or by changing the radial sizes of the corresponding beam-limit apertures within the array of beam-limit apertures. Objective lens 228 can focus beamlets 214, 216, and 218 onto a wafer 230 for imaging, and can form a plurality of probe spots 270, 272, and 274 on a surface of wafer 230.

Beam separator 222 can be a beam separator of Wien filter type generating an electrostatic dipole field and a magnetic dipole field. In some embodiments, if they are applied, the force exerted by the electrostatic dipole field on a charged particle (e.g., an electron) of beamlets 214, 216, and 218 can be substantially equal in magnitude and opposite in a direction to the force exerted on the charged particle by magnetic dipole field. Beamlets 214, 216, and 218 can, therefore, pass straight through beam separator 222 with zero deflection angle. However, the total dispersion of beamlets 214, 216, and 218 generated by beam separator 222 can also be non-zero. Beam separator 222 can separate secondary charged-particle beams 236, 238, and 240 from beamlets 214, 216, and 218 and direct secondary charged-particle beams 236, 238, and 240 towards secondary optical system 242.

Deflection scanning unit 226 can deflect beamlets 214, 216, and 218 to scan probe spots 270, 272, and 274 over a surface area of wafer 230. In response to the incidence of beamlets 214, 216, and 218 at probe spots 270, 272, and 274, secondary charged-particle beams 236, 238, and 240 may be emitted from wafer 230. Secondary charged-particle beams 236, 238, and 240 may comprise charged particles (e.g., electrons) with a distribution of energies. For example, secondary charged-particle beams 236, 238, and 240 may be secondary electron beams including secondary electrons (energies ≤50 eV) and backscattered electrons (energies between 50 eV and landing energies of beamlets 214, 216, and 218). Secondary optical system 242 can focus secondary charged-particle beams 236, 238, and 240 onto detection sub-regions 246, 248, and 250 of charged-particle detection device 244. Detection sub-regions 246, 248, and 250 may be configured to detect corresponding secondary charged-particle beams 236, 238, and 240 and generate corresponding signals (e.g., voltage, current, or the like) used to reconstruct an SCPM image of structures on or underneath the surface area of wafer 230.

The generated signals may represent intensities of secondary charged-particle beams 236, 238, and 240 and may be provided to image processing system 290 that is in communication with charged-particle detection device 244, primary projection optical system 220, and motorized wafer stage 280. The movement speed of motorized wafer stage 280 may be synchronized and coordinated with the beam deflections controlled by deflection scanning unit 226, such that the movement of the scan probe spots (e.g., scan probe spots 270, 272, and 274) may orderly cover regions of interests on the wafer 230. The parameters of such synchronization and coordination may be adjusted to adapt to different materials of wafer 230. For example, different materials of wafer 230 may have different resistance-capacitance characteristics that may cause different signal sensitivities to the movement of the scan probe spots.

The intensity of secondary charged-particle beams 236, 238, and 240 may vary according to the external or internal structure of wafer 230, and thus may indicate whether wafer 230 includes defects. Moreover, as discussed above, beamlets 214, 216, and 218 may be projected onto different locations of the top surface of wafer 230, or different sides of local structures of wafer 230, to generate secondary charged-particle beams 236, 238, and 240 that may have different intensities. Therefore, by mapping the intensity of secondary charged-particle beams 236, 238, and 240 with the areas of wafer 230, image processing system 290 may reconstruct an image that reflects the characteristics of internal or external structures of wafer 230.

In some embodiments, image processing system 290 may include an image acquirer 292, a storage 294, and a controller 296. Image acquirer 292 may comprise one or more processors. For example, image acquirer 292 may comprise a computer, server, mainframe host, terminals, personal computer, any kind of mobile computing devices, or the like, or a combination thereof. Image acquirer 292 may be communicatively coupled to charged-particle detection device 244 of beam tool 104 through a medium such as an electric conductor, optical fiber cable, portable storage media, IR, Bluetooth, internet, wireless network, wireless radio, or a combination thereof. In some embodiments, image acquirer 292 may receive a signal from charged-particle detection device 244 and may construct an image. Image acquirer 292 may thus acquire SCPM images of wafer 230. Image acquirer 292 may also perform various post-processing functions, such as generating contours, superimposing indicators on an acquired image, or the like. Image acquirer 292 may be configured to perform adjustments of brightness and contrast of acquired images. In some embodiments, storage 294 may be a storage medium such as a hard disk, flash drive, cloud storage, random access memory (RAM), other types of computer-readable memory, or the like. Storage 294 may be coupled with image acquirer 292 and may be used for saving scanned raw image data as original images, and post-processed images. Image acquirer 292 and storage 294 may be connected to controller 296. In some embodiments, image acquirer 292, storage 294, and controller 296 may be integrated together as one control unit.

In some embodiments, image acquirer 292 may acquire one or more SCPM images of a wafer based on an imaging signal received from charged-particle detection device 244. An imaging signal may correspond to a scanning operation for conducting charged particle imaging. An acquired image may be a single image comprising a plurality of imaging areas. The single image may be stored in storage 294. The single image may be an original image that may be divided into a plurality of regions. Each of the regions may comprise one imaging area containing a feature of wafer 230. The acquired images may comprise multiple images of a single imaging area of wafer 230 sampled multiple times over a time sequence. The multiple images may be stored in storage 294. In some embodiments, image processing system 290 may be configured to perform image processing steps with the multiple images of the same location of wafer 230.

In some embodiments, image processing system 290 may include measurement circuits (e.g., analog-to-digital converters) to obtain a distribution of the detected secondary charged particles (e.g., secondary electrons). The charged-particle distribution data collected during a detection time window, in combination with corresponding scan path data of beamlets 214, 216, and 218 incident on the wafer surface, can be used to reconstruct images of the wafer structures under inspection. The reconstructed images can be used to reveal various features of the internal or external structures of wafer 230, and thereby can be used to reveal any defects that may exist in the wafer.

In some embodiments, the charged particles may be electrons. When electrons of primary charged-particle beam 210 are projected onto a surface of wafer 230 (e.g., probe spots 270, 272, and 274), the electrons of primary charged-particle beam 210 may penetrate the surface of wafer 230 for a certain depth, interacting with particles of wafer 230. Some electrons of primary charged-particle beam 210 may elastically interact with (e.g., in the form of elastic scattering or collision) the materials of wafer 230 and may be reflected or recoiled out of the surface of wafer 230. An elastic interaction conserves the total kinetic energies of the bodies (e.g., electrons of primary charged-particle beam 210) of the interaction, in which the kinetic energy of the interacting bodies does not convert to other forms of energy (e.g., heat, electromagnetic energy, or the like). Such reflected electrons generated from elastic interaction may be referred to as backscattered electrons (BSEs). Some electrons of primary charged-particle beam 210 may inelastically interact with (e.g., in the form of inelastic scattering or collision) the materials of wafer 230. An inelastic interaction does not conserve the total kinetic energies of the bodies of the interaction, in which some or all of the kinetic energy of the interacting bodies convert to other forms of energy. For example, through the inelastic interaction, the kinetic energy of some electrons of primary charged-particle beam 210 may cause electron excitation and transition of atoms of the materials. Such inelastic interaction may also generate electrons exiting the surface of wafer 230, which may be referred to as secondary electrons (SEs). Yield or emission rates of BSEs and SEs depend on, e.g., the material under inspection and the landing energy of the electrons of primary charged-particle beam 210 landing on the surface of the material, among others. The energy of the electrons of primary charged-particle beam 210 may be imparted in part by its acceleration voltage (e.g., the acceleration voltage between the anode and cathode of charged-particle source 202 in FIG. 2). The quantity of BSEs and SEs may be more or fewer (or even the same) than the injected electrons of primary charged-particle beam 210.

The images generated by SEM may be used for defect inspection. For example, a generated image capturing a test device region of a wafer may be compared with a reference image capturing the same test device region. The reference image may be predetermined (e.g., by simulation) and include no known defect. If a difference between the generated image and the reference image exceeds a tolerance level, a potential defect may be identified. For another example, the SEM may scan multiple regions of the wafer, each region including a test device region designed as the same, and generate multiple images capturing those test device regions as manufactured. The multiple images may be compared with each other. If a difference between the multiple images exceeds a tolerance level, a potential defect may be identified.

Reference is now made to FIG. 3, which is a block diagram of an example synthetic defect image generation system, consistent with embodiments of the present disclosure. As shown in FIG. 3, synthetic defect image generation system 300 (also referred to as “apparatus 300”) may comprise a training apparatus 302 and a prediction apparatus 304. In some embodiments, synthetic defect image generation system 300 comprises one or more processors and memories. For example, synthetic defect image generation system 300 can comprise one or more computers, servers, mainframe hosts, terminals, personal computers, any kind of mobile computing devices, and the like, or combinations thereof. It is appreciated that in various embodiments synthetic defect image generation system 300 may be part of or may be separate from a charged-particle beam inspection system (e.g., EBI system 100 of FIG. 1). It is also appreciated that synthetic defect image generation system 300 may include one or more components or modules separate from and communicatively coupled to the charged-particle beam inspection system. In some embodiments, synthetic defect image generation system 300 may include one or more components (e.g., software modules) that can be implemented in controller 109 or system 290 as discussed herein. In some embodiments, training apparatus 302 and prediction apparatus 304 are implemented on separate computing devices or on a same computing device.

As shown in FIG. 3, training apparatus 302 may comprise a first training image acquirer 310, a second training image acquirer 315, a training condition data acquirer 320, and a model trainer 330.

According to some embodiments of the present disclosure, first training image acquirer 310 can acquire a defect-free inspection image of a wafer or sample. A defect-free inspection image is an inspection image that does not comprise a defect therein. In some embodiments, first training image acquirer 310 can acquire a plurality of defect-free inspection image. In the present disclosure, an inspection image can refer to an inspection image obtained by a charged-particle beam inspection system (e.g., electron beam inspection system 100 of FIG. 1). For example, an inspection image can be an electron beam image generated based on a detection signal from electron detection device 244 of electron beam tool 104. While a SEM image is referred to as an inspection image in some embodiments of the present disclosure, it will be appreciated that the present disclosure can be applied to any inspection images of a sample or wafer.

FIG. 4A illustrates example defect-free inspection images, consistent with embodiments of the present disclosure. In FIG. 4A, a first defect-free inspection image 411 and a second defect-free inspection image 412, each of which is a SEM image, are shown as an example. As shown in FIG. 4A, each defect-free inspection image 411 or 412 presents a pattern (e.g., a stripe pattern) of a sample without any defects. In some embodiments, defect-free inspection image 411 or 412 is used as a first training image acquired by first training image acquirer 310. While two defect-free inspection images are illustrated in FIG. 4A, it will be appreciated that any number of defect-free inspection images can be utilized for training in embodiments of the present disclosure.

Referring back to FIG. 3, according to some embodiments, first training image acquirer 310 may generate a defect-free inspection image based on a detection signal from electron detection device 244 of electron beam tool 104. In some embodiments, first training image acquirer 310 may be part of or may be separate from image acquirer 292 included in image processing system 290. In some embodiments, first training image acquirer 310 may obtain a defect-free inspection image generated by image acquirer 292 included in image processing system 290. In some embodiments, first training image acquirer 310 may obtain a defect-free inspection image from a storage device or system storing the defect-free inspection image.

In some embodiments of the present disclosure, second training image acquirer 315 can acquirer a defect-containing inspection image of a wafer or sample. A defect-containing inspection image is an inspection image that comprises a defect therein. In some embodiments, second training image acquirer 315 can acquire a plurality of defect-containing inspection image. FIG. 4B illustrates example defect-containing inspection images, consistent with embodiments of the present disclosure. In FIG. 4B, first defect-containing inspection image to fourth defect-containing inspection image 421 to 424, each of which is a SEM image, are shown as an example. As shown in FIG. 4B, each defect-containing inspection image 421 to 424 presents a pattern (e.g., a horizontal stripe pattern) of a sample with a defect. First defect-containing inspection image 421 has a vertical connection between two adjacent stripes, which is referred to as a bridge defect in the present disclosure. Second defect-containing inspection image 422 has a narrowed stripe, which is referred to as a narrow-line defect in the present disclosure. Third defect-containing inspection image 423 has a connection among three adjacent stripes, which is also referred to as a bride defect in the present disclosure. Forth defect-containing inspection image 424 has a widen stripe, which is referred to as a wide-line defect in the present disclosure. While four defect-containing inspection images are illustrated in FIG. 4B, it will be appreciated that any number of defect-containing inspection images can be utilized for training in embodiments of the present disclosure.

In some embodiments, second training image acquirer 315 may generate a defect-containing inspection image based on a detection signal from electron detection device 244 of electron beam tool 104. In some embodiments, second training image acquirer 315 may be part of or may be separate from image acquirer 292 included in image processing system 290. In some embodiments, second training image acquirer 315 may obtain a defect-containing inspection image generated by image acquirer 292 included in image processing system 290. In some embodiments, second training image acquirer 315 may obtain a defect-containing inspection image from a storage device or system storing the defect-free inspection image.

Referring back to FIG. 3, according to some embodiments of the present disclosure, training condition data acquirer 320 acquires a defect attribute combination of a defect-containing inspection image acquired by second training image acquirer 315. A defect attribute combination may comprise one or more defect attributes of a defect included in a defect-containing inspection image. In some embodiments, a defect attribute may comprise a defect type, defect size, defect location, defect strength, etc. According to some embodiments, a user can define defect attributes that represent any features or characteristics of a defect that are in user's interest. According to some embodiments, a defect associated with one defect-containing inspection image may have a plurality of defect attribute combinations. In some embodiments, a defect may have 2n-1 defect attribute combinations wherein n represents a number of defect attributes of the defect. For example, when a defect has two defined defect attributes, i.e., attribute 1 and attribute 2, the defect may have 3 defect attribute combinations, i.e., (attribute 1), (attribute 2), and (attribute 1, attribute 2). A user may select any combination of defect attributes as training defect attributes.

In some embodiments, a defect attribute combination can be represented as a condition vector for defects contained in a defect-containing inspection image. Each attribute of a defect can be encoded. In some embodiments, a defect attribute may comprise a defect type, defect size, defect location, defect strength, etc. A defect type may comprise a plurality of defect types such as a bridge defect, narrow line defect, wide line defect, etc. In some embodiments, a unique code can be assigned to each defect type. For example, a bridge defect is assigned with code 001, a narrow line defect is assigned with code 010, wide line defect is assigned with 100, etc. In some embodiments, such code mapping can be predetermined and known to a system and user. While a binary code is used for representing a defect type, it will be appreciated that any code word or any code length can be used in some embodiments of the present disclosure.

In some embodiments, a defect size can be represented by a length, width, diagonal length, etc. of a defect. In some embodiments, a defect size can be encoded by its actual size on an inspection image, scaled size, etc. For example, in first defect-containing inspection image 421, a defect size can be measured from an inspection image such as a vertical length of the bridge connecting the two stripes, a horizontal width of the bridge, etc. In some embodiments, a defect size may be encoded with a real figure representing the size instead of a binary code.

In some embodiments, a defect location can also be encoded according to a region including a defect in an inspection image. For example, an inspection image may be divided into a plurality of regions, and a unique code can be assigned to each region. FIG. 5 illustrates various defect locations in an inspection image as an example. In FIG. 5, a first inspection image 510 comprises a defect at a first row, which is indicated as a grey circle, a second inspection image 510 comprises a defect at a second row, and a third inspection image 530 comprises a defect at a third row. Three inspection images 510, 520, and 530 may be assigned with different codes as a defect location attribute. For example, the defect location (e.g., first row) of first inspection image 510 is assigned with code 1, the defect location (e.g., second row) of second inspection image 520 is assigned with code 2, and the defect location (e.g., third row) of third inspection image 530 is assigned with code 3. While identifying a defect location per row is illustrated with respect to FIG. 5, it will be appreciated that any location classifications (e.g., a distance from a center, a grid type region classification, etc.) can be used in embodiments of the present disclosure.

In some embodiments, a defect strength can be represented by a defect perceivability level, i.e., a defect strength can represent how easy to perceive a defect from an inspection image. A defect strength may be stronger when a defect is easy to detect, and vice versa. In some embodiments, a defect strength may be encoded according to a defect area. The defect area can be measured by a number of pixels that the defect spans in an inspection image. As the number of pixels is larger, the defect strength may become stronger. In some embodiments, a defect strength may be encoded according to a grey level difference between a defect area and a non-defect area in an inspection image. As a grey level difference between a defect area and a non-defect area is larger, the defect strength becomes stronger. As such, a defect strength can be encoded according to a quantized value of a defect strength.

According to some embodiments, each defect attribute combination can be coded into a condition vector. When a defect attribute combination has multiple defect attributes, e.g., attribute 1 as a defect type, attribute 2 as a defect size, attribute 3 as a defect strength, etc., a condition vector of a defect can be represented as (coded attribute 1, coded attribute 2, coded attribute 3, coded attribute 4, . . . ). For example, a defect attribute combination of first defect-containing inspection image 421 can be represented by a first condition vector with attribute 1 as a bridge defect, attribute 2 as a size of the bridge defect, attribute 3 as a location of the bridge defect, and attribute 4 as a defect strength. Encoded attributes can be used in a condition vector. In some embodiments, a condition vector may have only one defect attribute as a corresponding defect attribute combination has one defect attribute as an element.

According to some embodiments, a plurality of defect attribute combinations can be acquired for a plurality of defects of defect-containing inspection images. In some embodiments, multiple defect attribute combination can be acquired for a defect in a defect-containing inspection image. In some embodiments, training condition data acquirer 320 may generate attribute combinations as condition data from defect-containing inspection images acquired by second training image acquirer 315. In some embodiments, training condition data acquirer 320 may obtain training defect attribute combinations data corresponding to training defect-containing inspection images from a storage device or system storing the training condition data.

Referring back to FIG. 3, according to some embodiments of the present disclosure, model trainer 330 comprises a generator 331. Model trainer 330 is configured to train generator 331 to generate a synthetic inspection image with a defect as realistic as possible. Generator 331 is configured to acquire a first training image and condition data as inputs. Generator 331 is configured to generate, based on the first training image, a synthetic inspection image with a defect under a condition of the condition data. According to some embodiments, generator 331 is configured to acquire a first training image (i.e., defect-free inspection image) from first training image acquirer 310 and condition data (i.e., a defect attribute combination) from training condition data acquirer 320. Generator 331 can be configured to synthesize a defect having defect attributes identified by the defect attribute combination with the defect-free inspection image.

FIG. 6 illustrates an example predicted synthetic defect image 630 generated by generator 331. Synthetic defect image 630 is an example synthetic image generated by generator 331 based on first defect-free inspection image 411 of FIG. 4A as a first training image and a defect attribute combination of a defect included in first defect-containing inspection image 421 of FIG. 4B as condition data. In this example, a defect type (e.g., bridge defect) of a defect included in first defect-containing inspection image 421 of FIG. 4B is used as a defect attribute. It will be appreciated that other defect attributes of a defect included in first defect-containing inspection image 421 of FIG. 4B may be used to characterize a defect of interest. As shown in FIG. 6, a defect having characteristics of a defect defined by a defect attribute combination can be synthesized onto the input defect-free inspection image.

According to some embodiments, model trainer 330 may further comprise a discriminator 332 to train generator 331 to generate a realistic synthetic defect image. In some embodiments, a synthetic defect image generated by generator 331 is provided to discriminator 332, and discriminator 332 is configured to evaluate whether an input image is classified as a real inspection image with a defect under the condition data used for generating the synthetic image. In some embodiments, such classification can be made, e.g., at least partly based on real defect inspection image characteristics or synthetic defect image characteristics extracted from the input image. If discriminator 332 determines that the synthetic defect image is not a real inspection image with a defect, the result is used to update generator 331. For example, coefficients or weights of generator 331 can be updated or revised based on the determination of discriminator 332. Based on the updated coefficients or weights, generator 331 is configured to generate a synthetic defect image with the same set of inputs or with a different set of inputs and the generated synthetic defect image is provided to discriminator 332. This process can be repeated until discriminator 332 classifies a synthetic defect image generated by generator 331 as a real inspection image with a defect according with an associated defect attribute combination with a predetermined or acceptable probability. As discussed, in some embodiments, generator 331 is trained to fool discriminator 332 such that discriminator 332 classifies a synthetic defect image generated by generator 331 as a real inspection image. In some embodiments of the present disclosure, an objective of model trainer 330 is to train generator 331 to generate a synthetic defect image as realistic as possible and to increase an error rate of discriminator 332 with respect to a synthetic defect image generated by generator 331.

While a training process has been illustrated based on one training defect-free inspection image and one defect attribute combination with respect to FIG. 4A, it will be appreciated that a training process may be performed with any number of pairs of a training image and condition data or with any combinations of a training image and condition data. For example, generator 331 may receive any training image from a plurality of defect-free inspection images as an input training image and any condition data from a plurality of defect attribute combinations to generate a synthetic defect image, based on the received training image with a defect under the received condition data.

In some embodiments, a training process of generator 331 can be performed regularly, e.g., based on newly collected defect-containing inspection images, newly collected defect-free inspection images, or newly identified defect attribute combinations, etc. In some embodiments, a training process of generator 331 can be performed on demand when new defect-containing inspection images, new defect-free inspection images, or new identified defect attribute combinations are available. In some embodiments, a training process of generator 331 can be performed based on existing training data with an updated algorithm or model for generator 331.

According to some embodiments of the present disclosure, discriminator 332 is trained for evaluating a synthetic defect image generated by generator 331. In some embodiments, model trainer 330 is configured to train discriminator 332 via supervised learning. In supervised learning, training data fed to discriminator 332 may include desired output data. In some embodiments, discriminator 332 is trained with defect-containing inspection images acquired by second training image acquirer 315. Discriminator 332 is further provided with training condition data (e.g., a defect attribute combination) acquired by training condition data acquirer 320. During training, discriminator 332 can be trained to learn that an input defect-containing inspection image is a real inspection image containing a defect corresponding to condition data associated with the input defect-containing inspection image. For example, discriminator 332 is fed with first defect-containing inspection image 421 of FIG. 4B as a training image and a defect attribute combination associated with first defect-containing inspection image 421 as condition data. Discriminator 332 can be configured to evaluate whether the received first defect-containing inspection image 421 is classified as a real inspection image having a real defect corresponding to the received defect attribute combination. If discriminator 332 determines that first defect-containing inspection image 421 is not a real inspection image with the defect, the result is used to update discriminator 332.

In some embodiments, discriminator 332 is also trained with synthetic defect images generated by generator 331 and training condition data (e.g., defect attribute combinations) used for generating corresponding synthetic defect images. For example, discriminator 332 is fed with a predicted synthetic defect image generated by generator 331 and a defect attribute combination used for generating the predicted synthetic defect image by generator 331. Discriminator 332 can be configured to evaluate whether the predicted synthetic defect image is classified as a real inspection image under a condition of the defect attribute combination. If discriminator 332 determines that the predicted synthetic defect image is a real inspection image with the defect, the result is used to update discriminator 332.

In some embodiments, discriminator 332 may learn real defect inspection image characteristics or synthetic defect image characteristics during training. During training, coefficients or weights of discriminator 332 can be updated or revised so that discriminator 332 can supply correct inference results corresponding to the known solutions. After updating discriminator 332, the training process can be repeated until discriminator 332 properly infers whether an input image (e.g., defect-containing inspection image or predicted synthetic defect image) is classified as a real image with a defect defined by a defect attribute combination associated with the input image. While a training process has been illustrated based on one training defect-containing image and one condition data with respect to FIG. 4B and based on one synthetic defect image and an associated condition data, it will be appreciated that a training process may be performed with any number of pairs of a training image and condition data or with any combinations of a training image and condition data. For example, discriminator 332 may receive any image from a plurality of defect-containing inspection images as a training image and any condition data associated with the received training image as training condition data to evaluate whether the received inspection image is real under the received condition data. Similarly, discriminator 332 may receive any image from a plurality of synthetic defect images generated by generator 331 as a training image and condition data used when generating the received synthetic defect image as training condition data to evaluate whether the received synthetic defect image is real under the received condition data. In some embodiments, a training process of discriminator 332 may continue until discriminator 332 provides correct predictions with a predetermined probability or acceptable accuracy. For example, a training process of discriminator 332 may continue until discriminator 332 classifies a real defect-containing inspection image as a real inspection image having a defect defined by the associated defect attribute combination with a predetermined probability or acceptable accuracy. Similarly, a training process of discriminator 332 may continue until discriminator 332 classifies a synthetic defect image as a synthetic image under a condition of the associated defect attribute combination with a predetermined probability or acceptable accuracy.

In some embodiments, generator 331 or discriminator 332 can be implemented as a machine learning or deep learning network model. In some embodiments, generator 331 and discriminator 332 can be implemented as two separate neural networks interacting each other during training. For example, generator 331 and discriminator 332 can be implemented as a conditional generative adversarial network that is a class of machine learning frameworks. It will be also appreciated that any machine learning or deep learning network models can be used to perform processes and methods of generator 331 or discriminator 332 illustrated in the present disclosure.

Referring back to FIG. 3, prediction apparatus 304 may comprise an input image acquirer 340, input condition data acquirer 345, and an image predictor 350. According to some embodiments of the present disclosure, input image acquirer 340 can acquire a defect-free inspection image as an input image. An input defect-free inspection image is an inspection image of a wafer or a sample that is a target of a defect inspection or analysis. In some embodiments, an input defect-free inspection image can be one of a plurality of training defect-free inspection images. In some embodiments, an input defect-free inspection image can be an inspection image of a sample newly generated by, e.g., EBI system 100 of FIG. 1 or electron beam tool 104 of FIG. 2. FIG. 7A illustrates example input images 701 and 702, consistent with embodiments of the present disclosure. As shown in FIG. 7A, input defect-free inspection images 701 or 702 present a pattern of a sample without any defects.

Referring back to FIG. 3, input condition data acquirer 345 acquires a defect attribute combination of interest as input condition data. According to some embodiments, an input defect attribute combination can be selected from a plurality of defect attribute combinations used for training generator 331 or discriminator 332 during training process. According to some embodiments, a defect attribute combination can be represented as a condition vector to be provided to image predictor 350. In some embodiments, a defect attribute combination having a different combination from training defect combinations used for training generator 331 may be defined and provided to generator 331.

Image predictor 350 may be configured to acquire an input image from input image acquirer 340 and condition data from input condition data acquirer 345. Image predictor 350 is configured to generate a synthetic defect image based on the input image and the condition data. As illustrated in FIG. 3, image predictor 350 includes a trained generator 351 that is trained by training apparatus 302. Trained generator 351 may be configured to generate, based on the input image, a synthetic inspection image with a defect corresponding to the input condition data. For example, trained generator 351 is configured to synthesize a defect corresponding to the input defect attribute combination onto the input defect-free inspection image. As shown in FIG. 3, a synthetic defect image 360 is generated by image predictor 350 as a result. In some embodiments, predicted synthetic defect image 360 cam be used for image enhancement, defect inspection, or defect classification, etc. of an associated inspection image.

FIG. 7B and FIG. 7C illustrate example synthetic defect images generated based on input images 701 and 702 of FIG. 7A and various defect types, consistent with embodiments of the present disclosure. FIG. 7B illustrates a first set of example defect types and corresponding synthetic defect images. In FIG. 7B, columns 711 to 714 represent different defect types. For example, first column 711 represents an extrusion defect (i.e., first extrusion defect), second column 722 represents another extrusion defect (i.e., second extrusion defect), third column 713 represents a bridge defect, and third column 714 represents an open defect. First two rows 755 of FIG. 7B illustrate real defect images falling under a defect type of a corresponding column. For example, two images of first two rows in first column 711 are real inspection images with defects classified as a first extrusion defect type, two images of first two rows in second column 712 are real inspection images with defects classified as a second extrusion defect type, two images of first two rows in third column 713 are real inspection images with defects classified as a bridge defect type, and two images of first two rows in fourth column 714 are real inspection images with defects classified as an open defect type.

Last two rows 741 and 742 of FIG. 7B illustrate synthetic defect images generated based on an input defect-free inspection image under a defect attribute combination representing a defect type of a corresponding column. Third and fourth rows 741 and 742 illustrate synthetic defect images generated based on input images 701 and 702, respectively. For example, two images of third and fourth rows in first column 711 are synthetic defect images with defects that are synthesized to accord with a defect attribute combination representing a first extrusion defect type. Two images of third and fourth rows in second column 712 are synthetic defect images with defects that are synthesized to accord with a defect attribute combination representing a second extrusion defect type. Similarly, last two images in third column 713 and fourth column 714 are synthetic defect images with defects that are synthesized to accord with a defect attribute combination representing a bridge defect type and an open defect type, respectively.

FIG. 7C illustrates a second set of example defect types and corresponding synthetic defect images, consistent with embodiments of the present disclosure. FIG. 7C illustrates example synthetic defect images generated based on input images 701 and 702 of FIG. 7A and different defect types from those of FIG. 7B. Similarly, FIG. 7C, columns 715 to 718 represent different defect types. First column 715 to fourth column 718 of FIG. 7C represent a rough edge defect (i.e., first edge rough defect), another rough edge defect (i.e., second rough edge defect), a narrow line defect, and a wide line defect, respectively. Similar to FIG. 7B, first two rows 756 of FIG. 7C illustrate real defect images falling under a defect type of a corresponding column. Last two rows 743 and 744 of FIG. 7C illustrate synthetic defect images generated based on an input defect-free inspection image under a defect attribute combination representing a defect type of a corresponding column. Third and fourth rows 743 and 744 illustrate synthetic defect images generated based on input images 701 and 702 of FIG. 7A, respectively.

As shown in FIG. 7B and FIG. 7C, synthetic defect images that may be different from real defect images in the same column can be generated while the synthetic defect images have the same defect attribute combination (e.g., a defect type) as the real defect images. Therefore, according to some embodiments of the present disclosure, various defect images having a defect attribute of interest can be obtained.

FIG. 8 is a process flowchart representing an example method for generating synthetic defect images, consistent with embodiments of the present disclosure. For illustrative purpose, a method for generating synthetic defect images will be described referring to synthetic defect image generation system 300 of FIG. 3.

In step S810, a generator (e.g., generator 331 of FIG. 3) and a discriminator (e.g., discriminator 332 of FIG. 3) are trained. Step S810 can be performed by, for example, model trainer 330, among others. According to some embodiments, step S810 includes steps S811 to S814.

In step S811, a first set of a defect-free inspection image, a defect-containing inspection image, and a defect attribute combination are prepared for training. The defect-free containing inspection image is acquired from, for example, first training image acquirer 310, the defect-containing inspection image is acquired from, for example, second training image acquirer 315, and the defect attribute combination is acquired from, for example, training condition data acquirer 320. The defect attribute combination is associated with the defect-containing inspection image and can be represented as a condition vector.

In step S812, a synthetic defect image is generated based on a defect-free inspection image and a defect attribute combination. In step S812, a generator 331 is provided with a defect-free inspection image and a defect attribute combination that are prepared in step S811 as inputs. Generator 331 is configured to synthesize a defect having defect attributes identified by the defect attribute combination onto the defect-free inspection image.

In step S813, it is predicted whether a synthetic defect image and a defect-containing image are real under a condition of a defect attribute combination. In some embodiments, discriminator 332 is provided with the synthetic defect image generated in step S812, the defect-containing image prepared in step S811, and the defect attribute combination that is associated with the defect-containing image and is used for generating the synthetic defect image. In step S813, discriminator 332 is configured to make two predictions. The first prediction is whether the synthetic defect image is classified as a real inspection image under a condition of the defect attribute combination. The second prediction is whether the defect-containing inspection image is classified as a real inspection image under a condition of the defect attribute combination.

In step S814, generator 331 or discriminator 332 is updated according to the predictions made in step S813. In response to discriminator 332 predicting that the synthetic defect image is not a real inspection image, generator 331 can be updated to generate a more realistic synthetic image to fool discriminator 332. In response to discriminator 332 predicting that the synthetic defect image is a real inspection image or that the defect-containing inspection image is not a real inspection image, discriminator 332 can be updated to provide correct predictions. For example, coefficients or weights of generator 331 or discriminator 332 can be updated or revised based on the predictions made in step S813. According to some embodiments, steps S811 to S814 can be repeated for a second set of a defect free-inspection image, a defect attribute combination, and a defect-containing inspection image associated with the defect attribute combination based on the updated generator 331 and discriminator 332. Similarly, steps S811 to S814 can be repeated for a number of iterations. In some embodiments, the number of iterations is preset by a user or by a default number.

In step S820, a trained generator (e.g., trained generator 351 of FIG. 3) is acquired. Step S820 can be performed by, for example, image predictor 350, among others. In some embodiments, trained generator 351 can be a generator 331 trained in step S810. Trained generator 351 may be a machine learning-based network model having coefficients or weights revised or updated in step S810.

In step S830, a synthetic defect image is generated based on an input defect-free inspection image and a defect attribute combination. Step S830 can be performed by, for example, image predictor 350, among others. A defect-free inspection image is an inspection image of a wafer or a sample that is a target of a defect inspection or analysis. In some embodiments, an input defect-free inspection image can be one of plurality of training defect-free inspection images. In some embodiments, an input defect-free inspection image can be an inspection image of a sample newly generated by, e.g., EBI system 100 of FIG. 1 or electron beam tool 104 of FIG. 2. According to some embodiments, an input defect attribute combination can be selected from a plurality of defect attribute combinations used for training generator 331 in step S810. According to some embodiments, a defect attribute combination can be represented as a condition vector to be provided to image predictor 350.

In step S830, based on the input defect-free inspection image, a synthetic inspection image with a defect corresponding to the input defect attribute combination is generated. In some embodiments, a defect corresponding to the input defect attribute combination is synthesized onto the input defect-free inspection image. A synthetic defect image (e.g., the synthetic defect image 360 of FIG. 3) is generated in step S830 as a result. In some embodiments, predicted synthetic defect image 360 cam be used for image enhancement, defect inspection, or defect classification, etc. of an associated inspection image.

A non-transitory computer readable medium may be provided that stores instructions for a processor of a controller (e.g., controller 109 of FIG. 1) to carry out, among other things, image inspection, image acquisition, stage positioning, beam focusing, electric field adjustment, beam bending, condenser lens adjusting, activating charged-particle source, beam deflecting, and methods 800. Common forms of non-transitory media include, for example, a floppy disk, a flexible disk, hard disk, solid state drive, magnetic tape, or any other magnetic data storage medium, a Compact Disc Read Only Memory (CD-ROM), any other optical data storage medium, any physical medium with patterns of holes, a Random Access Memory (RAM), a Programmable Read Only Memory (PROM), and Erasable Programmable Read Only Memory (EPROM), a FLASH-EPROM or any other flash memory, Non-Volatile Random Access Memory (NVRAM), a cache, a register, any other memory chip or cartridge, and networked versions of the same.

The embodiments may further be described using the following clauses:

1. A method for generating a synthetic defect image, comprising:
acquiring a machine learning-based generator model;
providing a defect-free inspection image and a defect attribute combination as inputs to the generator model; and
generating by the generator model, based on the defect-free inspection image, a predicted synthetic defect image with a predicted defect that accords with the defect attribute combination.

2. The method of clause 1, wherein the defect attribute combination comprises at least one of a defect type, a defect size, a defect location, or defect strength.

3. The method of clause 1 or 2, wherein the defect attribute combination comprises only a single defect attribute.

4. The method of any one of clauses 1-3, further comprising:
encoding the defect attribute combination into a condition vector before providing the defect attribute combination to the generator model.

5. The method of any one of clauses 1-4, wherein the generator model is a conditional generative adversarial network model.

6. The method of any one of clauses 1-5, wherein the defect-free inspection image is a scanning electron microscope (SEM) image of a wafer.

7. The method of any one of clauses 1-6, wherein acquiring the machine learning-based generator model comprises pretraining the machine learning based-generator model, and wherein pretraining the machine learning based-generator comprises:
acquiring a first training defect-free inspection image and a first training defect attribute combination;
generating by the generator model, based on the first training defect-free inspection image, a first predicted synthetic defect image with a first predicted defect that accords with the first training defect attribute combination; and
evaluating, by a machine learning-based discriminator model, whether the first predicted synthetic defect image is classified as a real inspection image under a condition of the first training defect attribute combination.

8. The method of clause 7, wherein pretraining the machine learning based-generator model further comprises training the discriminator model, and wherein training the discriminator model comprises:
acquiring a first training defect-containing inspection image associated with the first training defect attribute combination; and
evaluating, by the discriminator model, whether the first defect-containing inspection image is classified as a real inspection image under a condition of the first training defect attribute combination.

9. The method of clauses 7 or 8, wherein pretraining the machine learning-based generator model comprises training the machine learning-based generator model with a plurality of training defect-free inspection images and a plurality of training defect attribute combinations associated with plurality of training defect-containing inspection images.

10. The method of clause 9, wherein the defect attribute combination is one of the plurality of training defect attribute combinations.

11. The method of any one of clauses 1-10, wherein the defect-free inspection image is a defect-free inspection image of a sample.

12. An apparatus for generating a synthetic defect image, comprising:
a memory storing a set of instructions; and
at least one processor configured to execute the set of instructions to cause the apparatus to perform:
   acquiring a machine learning-based generator model;
   providing a defect-free inspection image and a defect attribute combination as inputs to the generator model; and
   generating by the generator model, based on the defect-free inspection image, a predicted synthetic defect image with a predicted defect that accords with the defect attribute combination.

13. The apparatus of clause 12, wherein the defect attribute combination comprises at least one of a defect type, a defect size, a defect location, or defect strength.

14. The apparatus of clause 12 or 13, wherein the defect attribute combination comprises only a single defect attribute.

15. The apparatus of any one of clauses 12-14, wherein the at least one processor is configured to execute the set of instructions to cause the apparatus to further perform:
encoding the defect attribute combination into a condition vector before providing the defect attribute combination to the generator model.

16. The apparatus of any one of clauses 12-15, wherein the generator model is a conditional generative adversarial network model.

17. The apparatus of any one of clauses 12-16, wherein the defect-free inspection image is a scanning electron microscope (SEM) image of a wafer.

18. The apparatus of any one of clauses 12-17, wherein, in acquiring the machine learning-based generator model, the at least one processor is configured to execute the set of instructions to cause the apparatus to further perform pretraining the machine learning based-generator model, and wherein pretraining the machine learning based-generator model comprises:
acquiring a first training defect-free inspection image and a first training defect attribute combination;
generating, by the generator model, based on the first training defect-free inspection image, a first predicted synthetic defect image with a first predicted defect that accords with the first training defect attribute combination; and
evaluating, by a machine learning-based discriminator model, whether the first predicted synthetic defect image is classified as a real inspection image under a condition of the first training defect attribute combination.

19. The apparatus of clause 18, wherein, in pretraining the machine learning based-generator model, the at least one processor is configured to execute the set of instructions to cause the apparatus to further perform training the discriminator model, and wherein training the discriminator model comprises:
acquiring a first training defect-containing inspection image associated with the first training defect attribute combination; and
evaluating, by the discriminator model, whether the first defect-containing inspection image is classified as a real inspection image under a condition of the first training defect attribute combination.

20. The apparatus of clauses 18 or 19, wherein, in pretraining the machine learning-based generator model, the at least one processor is configured to execute the set of instructions to cause the apparatus to further perform training the machine learning-based generator model with a plurality of training defect-free inspection images and a plurality of training defect attribute combinations associated with plurality of training defect-containing inspection images.

21. The apparatus of clause 20, wherein the defect attribute combination is one of the plurality of training defect attribute combinations.

22. A non-transitory computer readable medium that stores a set of instructions that is executable by at least one processor of a computing device to cause the computing device to perform a method for generating a synthetic defect image, the method comprising:
acquiring a machine learning-based generator model;
providing a defect-free inspection image and a defect attribute combination as inputs to the generator model; and
generating by the generator model, based on the defect-free inspection image, a predicted synthetic defect image with a predicted defect that accords with the defect attribute combination.

23. The computer readable medium of clause 22, wherein the defect attribute combination comprises at least one of a defect type, a defect size, a defect location, or defect strength.

24. The computer readable medium of clause 22 or 23, wherein the defect attribute combination comprises only a single defect attribute.

25. The computer readable medium of any one of clauses 22-24, wherein the set of instructions that is executable by at least one processor of the computing device cause the computing device to further perform:

encoding the defect attribute combination into a condition vector before providing the defect attribute combination to the generator model.

26. The computer readable medium of any one of clauses 22-25, wherein the generator model is a conditional generative adversarial network model.

27. The computer readable medium of any one of clauses 22-26, wherein the defect-free inspection image is a scanning electron microscope (SEM) image of a wafer.

28. The computer readable medium of any one of clauses 22-27, wherein, in acquiring the machine learning-based generator model, the set of instructions that is executable by at least one processor of the computing device cause the computing device to further perform training the machine learning based-generator model, and wherein training the machine learning based-generator model comprises:
acquiring a first training defect-free inspection image and a first training defect attribute combination;
generating by the generator model, based on the first training defect-free inspection image, a first predicted synthetic defect image with a first predicted defect that accords with the first training defect attribute combination; and
evaluating, by a machine learning-based discriminator model, whether the first predicted synthetic defect image is classified as a real inspection image under a condition of the first training defect attribute combination.

29. The computer readable medium of clause 28, wherein, in pretraining the machine learning based-generator model, the set of instructions that is executable by at least one processor of the computing device cause the computing device to further perform training the discriminator model, and wherein training the discriminator model comprises:
acquiring a first training defect-containing inspection image associated with the first training defect attribute combination; and
evaluating, by the discriminator model, whether the first defect-containing inspection image is classified as a real inspection image under a condition of the first training defect attribute combination.

30. The computer readable medium of clauses 28 or 29, wherein, in pretraining the machine learning-based generator model, the set of instructions that is executable by at least one processor of the computing device cause the computing device to further perform training the machine learning-based generator model with a plurality of training defect-free inspection images and a plurality of training defect attribute combinations associated with plurality of training defect-containing inspection images.

31. The computer readable medium of clause 30, wherein the defect attribute combination is one of the plurality of training defect attribute combinations.

32. A method for training a machine learning-based generator model for generating a synthetic defect image, comprising:
acquiring a first training defect-free inspection image and a first training defect attribute combination associated with a first training defect-containing inspection image;
generating, by the generator model, based on the first training defect-free inspection image, a first predicted synthetic defect image with a first predicted defect that accords with the first training defect attribute combination;
evaluating whether the first predicted synthetic defect image is classified as a real inspection image under a condition of the first training defect attribute combination; and in response to the evaluation that the first predicted synthetic defect image is not a real inspection image, updating the generator model.

33. The method of clause 32, wherein the first training defect-free inspection image and the first training defect-containing inspection image are a scanning electron microscope (SEM) image of a wafer.

34. The method of clause 32 or 33, wherein the first training defect attribute combination comprises at least one of a defect type, a defect size, a defect location, or defect strength of a defect contained in the first training defect-containing inspection image.

35. The method of any one of clauses 32-34, wherein the first training defect attribute combination comprises only a single defect attribute.

36. The method of any one of clauses 32-35, further comprising:

encoding the first training defect attribute combination into a condition vector before providing the first training defect attribute combination to the generator model.

37. The method of any one of clauses 32-36, wherein the generator model is a conditional generative adversarial network model.

38. The method of any one of clauses 32-37, wherein evaluating whether the first predicted synthetic defect image is classified as a real inspection image comprises evaluating whether the first predicted synthetic defect image is classified as a real inspection image by a machine learning-based discriminator model and the method further comprises training the discriminator model, and wherein training the discriminator comprises:
providing the first training defect-containing inspection image and the first training defect attribute combination as inputs to the discriminator model;
evaluating, by the discriminator model, whether the first training defect-containing inspection image is classified as a real inspection image under a condition of the first training defect attribute combination; and
in response to the evaluation that the first training defect-containing inspection image is not a real inspection image, updating the discriminator model.

39. The method of any one of clauses 32-38, wherein evaluating whether the first predicted synthetic defect image is classified as a real inspection image comprises evaluating whether the first predicted synthetic defect image is classified as a real inspection image by a machine learning-based discriminator model and the method further comprises training the discriminator model, and wherein training the discriminator comprises:
in response to the evaluation that the first predicted synthetic defect image is a real inspection image, updating the discriminator model.

40. The method of any one of clauses 32-39, further comprising training the machine learning-based generator model with a plurality of training defect-free inspection images and a plurality of training defect attribute combinations associated with plurality of training real inspection images.

41. An apparatus for training a machine learning-based generator model for generating a synthetic defect image, comprising:
a memory storing a set of instructions; and
at least one processor configured to execute the set of instructions to cause the apparatus to perform:
   acquiring a first training defect-free inspection image and a first training defect attribute combination associated with a first training defect-containing inspection image;
   generating, by the generator model, based on the first training defect-free inspection image, a first predicted synthetic defect image with a first predicted defect that accords with the first training defect attribute combination;
   evaluating whether the first predicted synthetic defect image is classified as a real inspection image under a condition of the first training defect attribute combination; and
   in response to the evaluation that the first predicted synthetic defect image is not a real inspection image, updating the generator model.

42. The apparatus of clause 41, wherein the first training defect-free inspection image and the first training defect-containing inspection image are a scanning electron microscope (SEM) image of a wafer.

43. The apparatus of clause 41 or 42, wherein the first training defect attribute combination comprises at least one of a defect type, a defect size, a defect location, or defect strength of a defect contained in the first training defect-containing inspection image.

44. The apparatus of any one of clauses 41-43, wherein the first training defect attribute combination comprises only a single defect attribute.

45. The apparatus of any one of clauses 41-44, wherein the at least one processor is configured to execute the set of instructions to cause the apparatus to further perform:

encoding the first training defect attribute combination into a condition vector before providing the first training defect attribute combination to the generator model.

46. The apparatus of any one of clauses 41-45, wherein the generator model is a conditional generative adversarial network model.

47. The apparatus of any one of clauses 41-46, wherein evaluating whether the first predicted synthetic defect image is classified as a real inspection image comprises evaluating whether the first predicted synthetic defect image is classified as a real inspection image by a machine learning-based discriminator model and the at least one processor is configured to execute the set of instructions to cause the apparatus to further perform training the discriminator model, and wherein training the discriminator comprises:
providing the first training defect-containing inspection image and the first training defect attribute combination as inputs to the discriminator model;
evaluating, by the discriminator model, whether the first training defect-containing inspection image is classified as a real inspection image under a condition of the first training defect attribute combination; and
in response to the evaluation that the first training defect-containing inspection image is not a real inspection image, updating the discriminator model.

48. The apparatus of any one of clauses 41-47, wherein evaluating whether the first predicted synthetic defect image is classified as a real inspection image comprises evaluating whether the first predicted synthetic defect image is classified as a real inspection image by a machine learning-based discriminator model and the at least one processor is configured to execute the set of instructions to cause the apparatus to further perform training the discriminator model, and wherein training the discriminator model comprises:
in response to the evaluation that the first predicted synthetic defect image is a real inspection image, updating the discriminator model.

49. The apparatus of any one of clauses 41-48, wherein the at least one processor is configured to execute the set of instructions to cause the apparatus to further perform training the machine learning-based generator model with a plurality of training defect-free inspection images and a plurality of training defect attribute combinations associated with plurality of training real inspection images.

50. A non-transitory computer readable medium that stores a set of instructions that is executable by at least one processor of a computing device to cause the computing device to perform a method for training a machine learning-based generator model for generating a synthetic defect image, the method comprising:
acquiring a first training defect-free inspection image and a first training defect attribute combination associated with a first training defect-containing inspection image;
generating, by the generator model, based on the first training defect-free inspection image, a first predicted synthetic defect image with a first predicted defect that accords with the first training defect attribute combination;
evaluating whether the first predicted synthetic defect image is classified as a real inspection image under a condition of the first training defect attribute combination; and
in response to the evaluation that the first predicted synthetic defect image is not a real inspection image, updating the generator model.

51. The computer readable medium of clause 50, wherein the first training defect-free inspection image and the first training defect-containing inspection image are a scanning electron microscope (SEM) image of a wafer.

52. The computer readable medium of clause 50 or 51, wherein the first training defect attribute combination comprises at least one of a defect type, a defect size, a defect location, or defect strength of a defect contained in the first training defect-containing inspection image.

53. The computer readable medium of any one of clauses 50-52, wherein the first training defect attribute combination comprises only a single defect attribute.

54. The computer readable medium of any one of clauses 50-53, wherein the set of instructions that is executable by at least one processor of the computing device cause the computing device to further perform:
encoding the first training defect attribute combination into a condition vector before providing the first training defect attribute combination to the generator model.

55. The computer readable medium of any one of clauses 50-54, wherein the generator model is a conditional generative adversarial network model.

56. The computer readable medium of any one of clauses 50-55, wherein evaluating whether the first predicted synthetic defect image is classified as a real inspection image comprises evaluating whether the first predicted synthetic defect image is classified as a real inspection image by a machine learning-based discriminator model and the set of instructions that is executable by at least one processor of the computing device cause the computing device to further perform training the discriminator model, and wherein training the discriminator model comprises:
providing the first training defect-containing inspection image and the first training defect attribute combination as inputs to the discriminator model;
evaluating, by the discriminator model, whether the first training defect-containing inspection image is classified as a real inspection image under a condition of the first training defect attribute combination; and
in response to the evaluation that the first training defect-containing inspection image is not a real inspection image, updating the discriminator model.

57. The computer readable medium of any one of clauses 50-56, wherein evaluating whether the first predicted synthetic defect image is classified as a real inspection image comprises evaluating whether the first predicted synthetic defect image is classified as a real inspection image by a machine learning-based discriminator model and the set of instructions that is executable by at least one processor of the computing device cause the computing device to further perform training the discriminator model, and wherein training the discriminator model comprises:
in response to the evaluation that the first predicted synthetic defect image is a real inspection image, updating the discriminator model.

58. The computer readable medium of any one of clauses 50-57, wherein the set of instructions that is executable by at least one processor of the computing device cause the computing device to further perform training the machine learning-based generator model with a plurality of training defect-free inspection images and a plurality of training defect attribute combinations associated with plurality of training real inspection images.

It will be appreciated that the embodiments of the present disclosure are not limited to the exact construction that has been described above and illustrated in the accompanying drawings, and that various modifications and changes may be made without departing from the scope thereof. The present disclosure has been described in connection with various embodiments, other embodiments of the invention will be apparent to those skilled in the art from consideration of the specification and practice of the invention disclosed herein. It is intended that the specification and examples be considered as exemplary only, with a true scope and spirit of the invention being indicated by the following claims.

The descriptions above are intended to be illustrative, not limiting. Thus, it will be apparent to one skilled in the art that modifications may be made as described without departing from the scope of the claims set out below.

1. An apparatus for generating a synthetic defect image, comprising:
a memory storing a set of instructions; and
at least one processor configured to execute the set of instructions to cause the apparatus to perform:
acquiring a machine learning-based generator model;
providing a defect-free inspection image and a defect attribute combination as inputs to the generator model; and
generating by the generator model, based on the defect-free inspection image, a predicted synthetic defect image with a predicted defect that accords with the defect attribute combination.

2. The apparatus of claim 1, wherein the defect attribute combination comprises at least one of a defect type, a defect size, a defect location, or defect strength.

3. The apparatus of claim 1, wherein the defect attribute combination comprises only a single defect attribute.

4. The apparatus of claim 1, wherein the at least one processor is configured to execute the set of instructions to cause the apparatus to further perform:
encoding the defect attribute combination into a condition vector before providing the defect attribute combination to the generator model.

5. The apparatus of claim 1, wherein the generator model is a conditional generative adversarial network model.

6. The apparatus of claim 1, wherein the defect-free inspection image is a scanning electron microscope (SEM) image of a wafer.

7. The apparatus of claim 1, wherein, in acquiring the machine learning-based generator model, the at least one processor is configured to execute the set of instructions to cause the apparatus to further perform pretraining the machine learning based-generator model, and wherein pretraining the machine learning based-generator model comprises:
acquiring a first training defect-free inspection image and a first training defect attribute combination;
generating, by the generator model, based on the first training defect-free inspection image, a first predicted synthetic defect image with a first predicted defect that accords with the first training defect attribute combination; and
evaluating, by a machine learning-based discriminator model, whether the first predicted synthetic defect image is classified as a real inspection image under a condition of the first training defect attribute combination.

8. The apparatus of claim 7, wherein, in pretraining the machine learning based-generator model, the at least one processor is configured to execute the set of instructions to cause the apparatus to further perform training the discriminator model, and wherein training the discriminator model comprises:
acquiring a first training defect-containing inspection image associated with the first training defect attribute combination; and
evaluating, by the discriminator model, whether the first defect-containing inspection image is classified as a real inspection image under a condition of the first training defect attribute combination.

9. The apparatus of claim 7, wherein, in pretraining the machine learning-based generator model, the at least one processor is configured to execute the set of instructions to cause the apparatus to further perform training the machine learning-based generator model with a plurality of training defect-free inspection images and a plurality of training defect attribute combinations associated with plurality of training defect-containing inspection images.

10. The apparatus of claim 9, wherein the defect attribute combination is one of the plurality of training defect attribute combinations.

11. A non-transitory computer readable medium that stores a set of instructions that is executable by at least one processor of a computing device to cause the computing device to perform a method for generating a synthetic defect image, the method comprising:
acquiring a machine learning-based generator model;
providing a defect-free inspection image and a defect attribute combination as inputs to the generator model; and
generating by the generator model, based on the defect-free inspection image, a predicted synthetic defect image with a predicted defect that accords with the defect attribute combination.

12. The computer readable medium of claim 11, wherein the defect attribute combination comprises at least one of a defect type, a defect size, a defect location, or defect strength.

13. The computer readable medium of claim 11, wherein the defect attribute combination comprises only a single defect attribute.

14. The computer readable medium of claim 11, wherein the set of instructions that is executable by at least one processor of the computing device cause the computing device to further perform:
encoding the defect attribute combination into a condition vector before providing the defect attribute combination to the generator model.

15. The computer readable medium of claim 11, wherein the generator model is a conditional generative adversarial network model.

16. A method for generating a synthetic defect image, comprising:
acquiring a machine learning-based generator model;
providing a defect-free inspection image and a defect attribute combination as inputs to the generator model; and
generating by the generator model, based on the defect-free inspection image, a predicted synthetic defect image with a predicted defect that accords with the defect attribute combination.

17. The method of claim 16, wherein the defect attribute combination comprises at least one of a defect type, a defect size, a defect location, or defect strength.

18. The method of claim 16, wherein the defect attribute combination comprises only a single defect attribute.

19. The method of claim 16, further comprising:
encoding the defect attribute combination into a condition vector before providing the defect attribute combination to the generator model.

20. The method of claim 16, wherein the generator model is a conditional generative adversarial network model.
